(19) United States
(12) Patent Application Publication
(10) Pub. No.: US 2023/0297161 A1
(43) Pub. Date: Sep. 21, 2023

(54) AUGMENTED REALITY VISUAL OR ACOUSTIC FEEDBACK

(71) Applicant: Snap Inc., Santa Monica, CA (US)

(72) Inventor: Sharon Moll, Lachen (CH)

(21) Appl. No.: 17/655,125

(22) Filed: Mar. 16, 2022

(51) Int. Cl. G06F 3/01; G06F 3/16; G06F 3/04815; G06T 19/00

(52) U.S. Cl. CPC G06F 3/011; G06F 3/167; G06F 3/017; G06F 3/04815; G06T 19/003; G06T 19/006

(57) ABSTRACT

Feedback is provided to the user of an augmented or virtual reality device based on detecting the proximity of a user's hand to an interactive virtual object that is being displayed by the device. More particularly, a method of providing feedback in display device including a camera, comprises displaying a virtual object on the display device, tracking a user's hand in the field of view of the camera, determining proximity of the user's hand to the virtual object, and based on proximity of the user's hand to the virtual object, providing audible or visual user feedback to the user of the device.

### TECHNICAL FIELD

The present disclosure relates generally to display devices and more particularly to display devices used for augmented and virtual reality.

### BACKGROUND

A head-worn device may be implemented with a transparent or semi-transparent display through which a user of the head-worn device can view the surrounding environment. Such devices enable a user to see through the transparent or semi-transparent display to view the surrounding environment, and to also see objects (e.g., virtual objects such as 3D renderings, images, video, text, and so forth) that are generated for display to appear as a part of, and/or overlaid upon, the surrounding environment. This is typically referred to as “augmented reality” or “AR.” A head-worn device may additionally completely occlude a user's visual field and display a virtual environment through which a user may move or be moved. This is typically referred to as “virtual reality” or “VR.” Collectively, AR and VR as known as “XR” where “X” is understood to stand for either “augmented” or “virtual.” As used herein, the term XR refers to either or both augmented reality and virtual reality as traditionally understood, unless the context indicates otherwise.

A user of the head-worn device may access and use a computer software application to perform various tasks or engage in an entertaining activity. To use the computer software application, the user interacts with a 3D user interface provided by the head-worn device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a head-worn device, in accordance with some examples.

FIG. 2 illustrates a further view of the head-worn device of FIG. 1, in accordance with some examples.

FIG. 3 is a block diagram illustrating a networked system 300 including details of the head-worn device of FIG. 1, in accordance with some examples.

FIG. 4 illustrates a 3D user interface according to some examples.

FIG. 5A and FIG. 5B illustrate two examples of interactive virtual objects and their associated rules and attributes.

FIG. 6 illustrates a UI architecture 600 that may be used to implement feedback, according to some examples.

FIG. 7A and FIG. 7B illustrate user feedback provided in an AR wearable device such as the glasses 100, according to some examples.

FIG. 8 is a flowchart 800 illustrating a method of providing feedback, according to some examples.

FIG. 9 is a diagrammatic representation of a networked environment in which the present disclosure may be deployed, in accordance with some examples.

FIG. 10 is a block diagram showing a software architecture within which the present disclosure may be implemented, in accordance with some examples.

FIG. 11 is a diagrammatic representation of a machine, in the form of a computer system within which a set of instructions may be executed for causing the machine to perform any one or more of the methodologies discussed herein in accordance with some examples.

### DETAILED DESCRIPTION

Some head-worn XR devices, such as AR glasses, include a transparent or semi-transparent display that enables a user to see through the transparent or semi-transparent display to view the surrounding environment. Additional information or objects (e.g., virtual objects such as 3D renderings, images, video, text, and so forth) are shown on the display and appear as a part of, and/or overlaid upon, the surrounding environment to provide an augmented reality (AR) experience for the user. The display may for example include a waveguide that receives a light beam from a projector but any appropriate display for presenting augmented or virtual content to the wearer may be used.

As referred to herein, the phrase “augmented reality experience,” includes or refers to various image processing operations corresponding to an image modification, filter, media overlay, transformation, and the like, as described further herein. In some examples, these image processing operations provide an interactive experience of a real-world environment, where objects, surfaces, backgrounds, lighting and so forth in the real world are enhanced by computer-generated perceptual information. In this context an “augmented reality effect” comprises the collection of data, parameters, and other assets used to apply a selected augmented reality experience to an image or a video feed. In some examples, augmented reality effects are provided by Snap, Inc. under the registered trademark LENSES.

In some examples, a user's interaction with software applications executing on an XR device is achieved using a 3D User Interface. The 3D user interface includes virtual objects displayed to a user by the XR device in a 3D render displayed to the user. In the case of AR, the user perceives the virtual objects as objects within the real world as viewed by the user while wearing the XR device. In the case of VR, the user perceives the virtual objects as objects within the virtual world as viewed by the user while wearing the XR device. To allow the user to interact with the virtual objects, the XR device detects the user's hand positions and movements and uses those hand positions and movements to determine the user's intentions in manipulating the virtual objects.

Generation of the 3D user interface and detection of the user's interactions with the virtual objects may also include detection of real world objects (e.g., faces, hands, bodies, cats, dogs, surfaces, objects), tracking of such real world objects as they leave, enter, and move around the field of view in video frames, and the modification or transformation of such real world objects as they are tracked. In various examples, different methods for detecting the real world objects and achieving such transformations may be used. For example, some examples may involve generating a 3D mesh model of a real world object or real world objects, and using transformations and animated textures of the model within the video frames to achieve the transformation. In other examples, tracking of points on a real world object may be used to place an image or texture, which may be two dimensional or three dimensional, at the tracked position. In still further examples, neural network analysis of video frames may be used to place images, models, or textures in content (e.g., images or frames of video). XR effect data thus may include both the images, models, and textures used to create transformations in content, as well as additional modeling and analysis information used to achieve such transformations with real world object detection, tracking, and placement.

The virtual objects can be UI elements like buttons, sliders, input fields and so forth, as well as other kinds of other arbitrary objects, such as puzzle pieces in a game or a cup of coffee. In many use cases, the user will be able to interact with these virtual objects using one or both of their hands, based on hand tracking performed by the XR device. A user can in some examples press a button, pinch and drag a slider to change a value, or grab a cup of coffee and move it around in space. To indicate that the user can interact with a particular virtual object, namely both that the virtual object provides interactive actions and that the user's hand is close enough to interact with it, a visual feedback and/or acoustic feedback can be given to the user.

For example, in a puzzle game, in which the user can move virtual puzzle pieces with their hands, a puzzle piece can change its color, size, texture/look or acoustic feedback can be given (playing a particular sound) when the user's hand or a user's fingers are close enough in relative 3D space to the piece, indicating that the intended user interface action can be performed. The user can then for example take hold of the puzzle piece by using an appropriate gesture such as moving an index finger towards a thumb in a grasping motion, which is recognized by the XR device as such.

Further visual/acoustic feedback can then be given to indicate that the user is holding the virtual object and interacting with it, such as dragging it around in the case of a virtual puzzle piece. In response to determining that the action is no longer being performed, for example by the recognition of an appropriate gesture such as the user moving their index finger away from their thumb in a releasing motion, the visual/acoustic feedback will stop. Providing feedback in this manner improves accessibility and the user experience, and improves the functioning of the XR system. It also mitigates the fact that the user does not receive haptic feedback as in the real world.

In some examples, provided is a computer-implemented method for providing feedback in a display device including a camera. The method includes displaying a virtual object on the display device, tracking a user's hand in a field of view of the camera, determining proximity of the user's hand to the virtual object, and based on proximity of the user's hand to the virtual object, providing user feedback. The method may further include detecting a gesture performed by the user's hand when the user's hand is in proximity to the virtual object, determining that the gesture is applicable to the virtual object, and based on determining that the gesture is applicable to the virtual object, updating a state of the virtual object. Determining the proximity of the user's hand to the virtual object may include determining intersection of the user's hand with a bounding box surrounding the virtual object.

The computer-implemented method may further include comparing a depth from the display device to the user's hand with a depth from the display device to the virtual object, and based on the depth from the display device to the user's hand not being within a range of the depth from the display device to the virtual object, determining that the user's hand is not in proximity to the virtual object. A plurality of virtual objects may be displayed on the display device, each virtual object having an associated depth from the display device, the method further comprising comparing a depth from the display device to the user's hand with each of the depths of the plurality of virtual objects, and based on the depth from the display device to the user's hand not being within a range of the depth from the display device to a particular virtual object, determining that the user's hand is not in proximity to the particular virtual object.

In some examples, the virtual object is an elongate virtual object and the method further includes changing a graphical property of the elongate virtual object at a first location along the elongate virtual object corresponding to the proximity of the user's hand, the user's hand being a first of the user's hands, tracking a user's second hand in the field of view of the camera, determining proximity of the user's second hand to the virtual object, and based on proximity of the user's second hand to the virtual object, changing a graphical property of the elongate virtual object at a second location along the elongate virtual object corresponding to the proximity of the user's second hand.

The feedback may include audio feedback that increases in frequency (such as an increase in the tone or in the rate of repetition of the sound) as the user's hand approaches the virtual object. The feedback may also include changing visual properties of other virtual objects in a vicinity of the virtual object.

In some examples, the virtual object includes a stack of subsidiary virtual objects, the method further comprising determining that the user's hand is in the proximity of a particular subsidiary virtual objects, and based on determining that the user's hand is in the proximity of the particular virtual object, altering its properties so that it is visible in or adjacent to the stack of subsidiary virtual objects.

Also provided is a non-transitory computer-readable storage medium, the computer-readable storage medium including instructions that when executed by a computer, cause the computer to perform operations for providing feedback in a display device including a camera, according to any of the methods and limitations described above, including but not limited to operations comprising: displaying a virtual object on the display device, tracking a user's hand in a field of view of the camera, determining proximity of the user's hand to the virtual object, and based on proximity of the user's hand to the virtual object, providing user feedback.

Also provided is a computing apparatus comprising a processor and a memory storing instructions that, when executed by the processor, configure the apparatus to perform operations for providing feedback in a display device including a camera, according to any of the methods and limitations described above, including but not limited to operations comprising: displaying a virtual object on the display device, tracking a user's hand in a field of view of the camera, determining proximity of the user's hand to the virtual object, and based on proximity of the user's hand to the virtual object, providing user feedback.

Other technical features may be readily apparent to one skilled in the art from the following figures, descriptions, and claims.

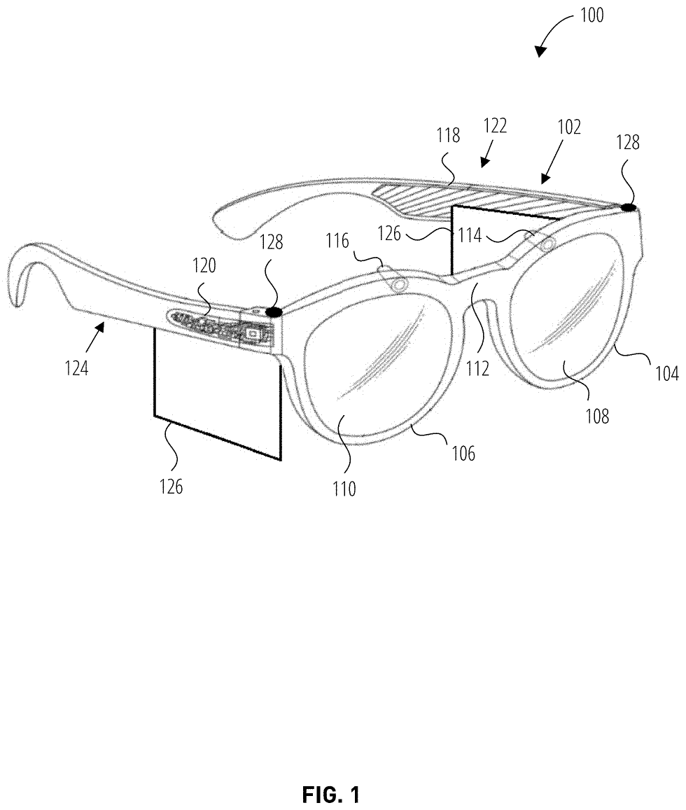

FIG. 1 is a perspective view of a head-worn XR device (e.g., glasses 100), in accordance with some examples. The glasses 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the glasses 100.

The frame 102 additionally includes a left arm or temple piece 122 and a right arm or temple piece 124. In some examples the frame 102 can be formed from a single piece of material so as to have a unitary or integral construction.

The glasses 100 can include a computing device, such as a computer 120, which can be of any suitable type so as to be carried by the frame 102 and, in one or more examples, of a suitable size and shape so as to be partially disposed in one of the temple piece 122 or the temple piece 124. The computer 120 can include one or more processors with memory, wireless communication circuitry, and a power source. As discussed below, the computer 120 comprises low-power circuitry, high-speed circuitry, and a display processor. Various other examples may include these elements in different configurations or integrated together in different ways. Additional details of aspects of computer 120 may be implemented as illustrated by the data processor 302 discussed below.

The computer 120 additionally includes a battery 118 or other suitable portable power supply. In some examples, the battery 118 is disposed in left temple piece 122 and is electrically coupled to the computer 120 disposed in the right temple piece 124. The glasses 100 can include a connector or port (not shown) suitable for charging the battery 118, a wireless receiver, transmitter or transceiver (not shown), or a combination of such devices.

The glasses 100 include a first or left camera 114 and a second or right camera 116. Although two cameras are depicted, other examples contemplate the use of a single or additional (i.e., more than two) cameras. In one or more examples, the glasses 100 include any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide video frame data for use by the glasses 100 to extract 3D information from a real world scene.

The glasses 100 may also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input may be provided by one or more buttons 128, which in the illustrated examples are provided on the outer upper edges of the left optical element holder 104 and right optical element holder 106. The one or more touchpads 126 and buttons 128 provide a means whereby the glasses 100 can receive input from a user of the glasses 100.

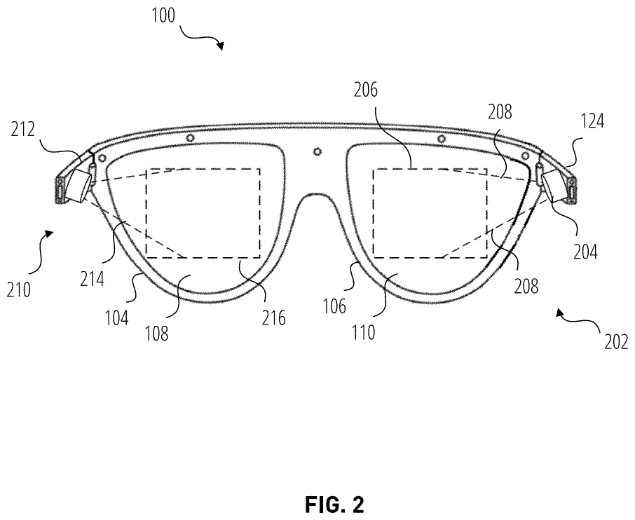

FIG. 2 illustrates the glasses 100 from the perspective of a user. For clarity, a number of the elements shown in FIG. 1 have been omitted. As described in FIG. 1, the glasses 100 shown in FIG. 2 include left optical element 108 and right optical element 110 secured within the left optical element holder 104 and the right optical element holder 106 respectively.

The glasses 100 include forward optical assembly 202 comprising a right projector 204 and a right near eye display 206, and a forward optical assembly 210 including a left projector 212 and a left near eye display 216.

In some examples, the near eye displays are waveguides. The waveguides include reflective or diffractive structures (e.g., gratings and/or optical elements such as mirrors, lenses, or prisms). Light 208 emitted by the projector 204 encounters the diffractive structures of the waveguide of the near eye display 206, which directs the light towards the right eye of a user to provide an image on or in the right optical element 110 that overlays the view of the real world seen by the user. Similarly, light 214 emitted by the projector 212 encounters the diffractive structures of the waveguide of the near eye display 216, which directs the light towards the left eye of a user to provide an image on or in the left optical element 108 that overlays the view of the real world seen by the user. The combination of a GPU, the forward optical assembly 202, the left optical element 108, and the right optical element 110 provide an optical engine of the glasses 100. The glasses 100 use the optical engine to generate an overlay of the real world view of the user including display of a 3D user interface to the user of the glasses 100.

It will be appreciated however that other display technologies or configurations may be utilized within an optical engine to display an image to a user in the user's field of view. For example, instead of a projector 204 and a waveguide, an LCD, LED or other display panel or surface may be provided.

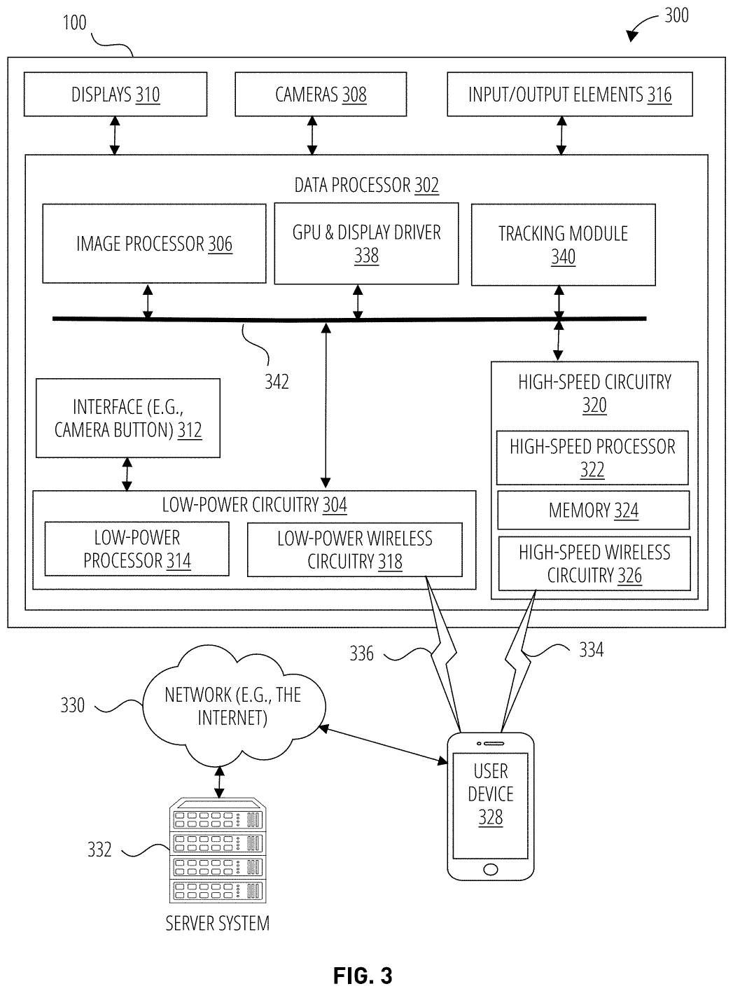

In use, a user of the glasses 100 will be presented with information, content and various 3D user interfaces on the near eye displays. As described in more detail herein, the user can then interact with the glasses 100 using a touchpad 126 and/or the buttons 128, voice inputs or touch inputs on an associated device (e.g., user device 328 illustrated in FIG. 3), and/or hand movements, locations, and positions detected by the glasses 100.

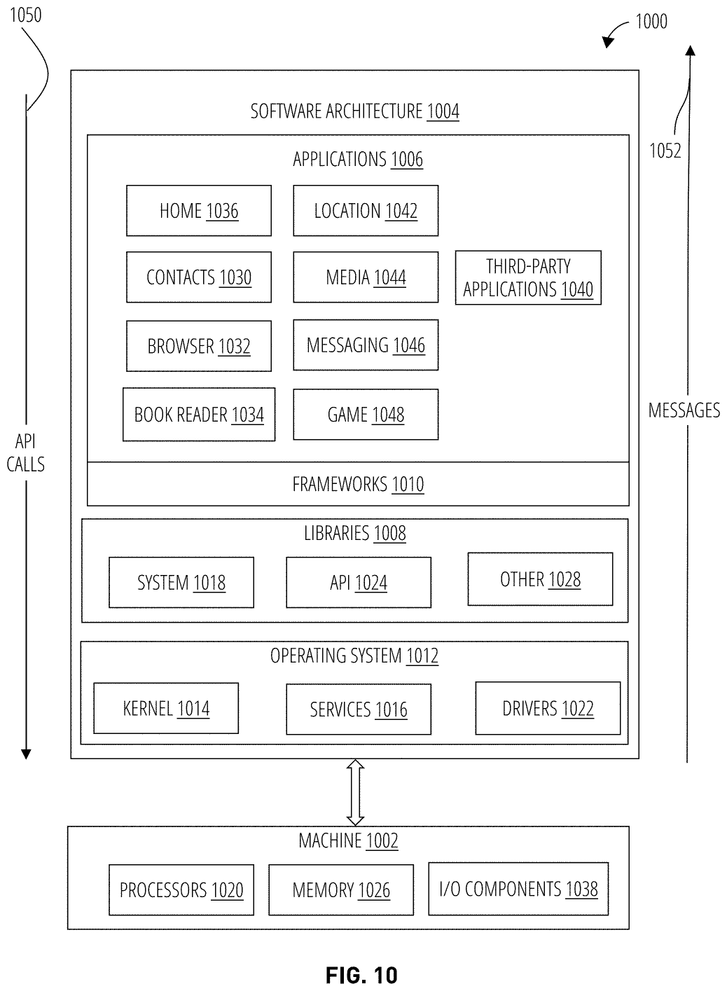

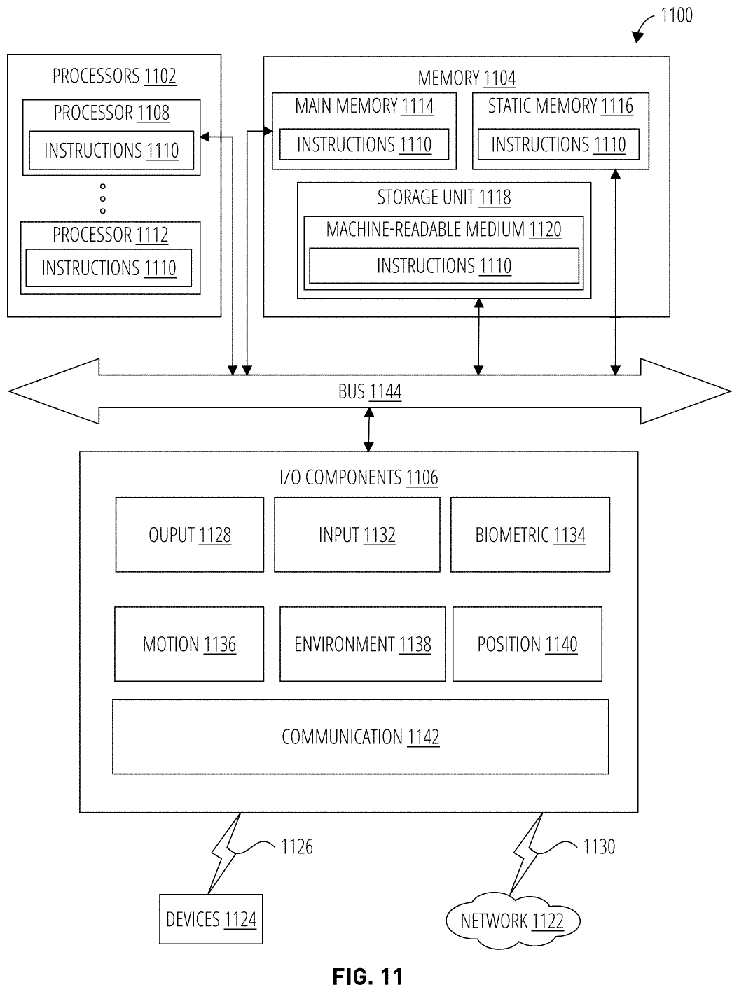

FIG. 3 is a block diagram illustrating a networked system 300 including details of the glasses 100, in accordance with some examples. The networked system 300 includes the glasses 100, a user device 328, and a server system 332. The user device 328 may be a smartphone, tablet, phablet, laptop computer, access point, or any other such device capable of connecting with the glasses 100 using a low-power wireless connection 336 and/or a high-speed wireless connection 334. The user device 328 is connected to the server system 332 via the network 330. The network 330 may include any combination of wired and wireless connections. The server system 332 may be one or more computing devices as part of a service or network computing system. The user device 328 and any elements of the server system 332 and network 330 may be implemented using details of the software architecture 1004 or the machine 1100 described in FIG. 10 and FIG. 11 respectively.

The glasses 100 include a data processor 302, displays 310, one or more cameras 308, and additional input/output elements 316. The input/output elements 316 may include microphones, audio speakers, biometric sensors, additional sensors, or additional display elements integrated with the data processor 302. Examples of the input/output elements 316 are discussed further with respect to FIG. 10 and FIG. 11. For example, the input/output elements 316 may include any of I/O components 1106 including output components 1128, motion components 1136, and so forth. Examples of the displays 310 are discussed in FIG. 2. In the particular examples described herein, the displays 310 include a display for the user's left and right eyes.

The data processor 302 includes an image processor 306 (e.g., a video processor), a GPU & display driver 338, a tracking module 340, an interface 312, low-power circuitry 304, and high-speed circuitry 320. The components of the data processor 302 are interconnected by a bus 342.

The interface 312 refers to any source of a user command that is provided to the data processor 302. In one or more examples, the interface 312 is a physical button that, when depressed, sends a user input signal from the interface 312 to a low-power processor 314. A depression of such button followed by an immediate release may be processed by the low-power processor 314 as a request to capture a single image, or vice versa. A depression of such a button for a first period of time may be processed by the low-power processor 314 as a request to capture video data while the button is depressed, and to cease video capture when the button is released, with the video captured while the button was depressed stored as a single video file. Alternatively, depression of a button for an extended period of time may capture a still image. In some examples, the interface 312 may be any mechanical switch or physical interface capable of accepting user inputs associated with a request for data from the cameras 308. In other examples, the interface 312 may have a software component, or may be associated with a command received wirelessly from another source, such as from the user device 328.

The image processor 306 includes circuitry to receive signals from the cameras 308 and process those signals from the cameras 308 into a format suitable for storage in the memory 324 or for transmission to the user device 328. In one or more examples, the image processor 306 (e.g., video processor) comprises a microprocessor integrated circuit (IC) customized for processing sensor data from the cameras 308, along with volatile memory used by the microprocessor in operation.

The low-power circuitry 304 includes the low-power processor 314 and the low-power wireless circuitry 318. These elements of the low-power circuitry 304 may be implemented as separate elements or may be implemented on a single IC as part of a system on a single chip. The low-power processor 314 includes logic for managing the other elements of the glasses 100. As described above, for example, the low-power processor 314 may accept user input signals from the interface 312. The low-power processor 314 may also be configured to receive input signals or instruction communications from the user device 328 via the low-power wireless connection 336. The low-power wireless circuitry 318 includes circuit elements for implementing a low-power wireless communication system. Bluetooth™ Smart, also known as Bluetooth™ low energy, is one standard implementation of a low power wireless communication system that may be used to implement the low-power wireless circuitry 318. In other examples, other low power communication systems may be used.

The high-speed circuitry 320 includes a high-speed processor 322, a memory 324, and a high-speed wireless circuitry 326. The high-speed processor 322 may be any processor capable of managing high-speed communications and operation of any general computing system used for the data processor 302. The high-speed processor 322 includes processing resources used for managing high-speed data transfers on the high-speed wireless connection 334 using the high-speed wireless circuitry 326. In some examples, the high-speed processor 322 executes an operating system such as a LINUX operating system or other such operating system such as the operating system 1012 of FIG. 10. In addition to any other responsibilities, the high-speed processor 322 executing a software architecture for the data processor 302 is used to manage data transfers with the high-speed wireless circuitry 326. In some examples, the high-speed wireless circuitry 326 is configured to implement Institute of Electrical and Electronic Engineers (IEEE) 802.11 communication standards, also referred to herein as Wi-Fi. In other examples, other high-speed communications standards may be implemented by the high-speed wireless circuitry 326.

The memory 324 includes any storage device capable of storing camera data generated by the cameras 308 and the image processor 306. While the memory 324 is shown as integrated with the high-speed circuitry 320, in other examples, the memory 324 may be an independent standalone element of the data processor 302. In some such examples, electrical routing lines may provide a connection through a chip that includes the high-speed processor 322 from image processor 306 or the low-power processor 314 to the memory 324. In other examples, the high-speed processor 322 may manage addressing of the memory 324 such that the low-power processor 314 will boot the high-speed processor 322 any time that a read or write operation involving the memory 324 is desired.

The tracking module 340 estimates the position and orientation (the “pose”) of the glasses 100. For example, the tracking module 340 uses image data and corresponding inertial data from the cameras 308 and the position components 1140, as well as GPS data, to track a location and determine a pose of the glasses 100 relative to a frame of reference (e.g., real-world environment). The tracking module 340 continually gathers and uses updated sensor data describing movements of the glasses 100 to determine updated three-dimensional poses of the glasses 100 that indicate changes in the relative position and orientation relative to physical objects in the real-world environment. The tracking module 340 permits visual placement of virtual objects relative to physical objects by the glasses 100 within the field of view of the user via the displays 310.

The GPU & display driver 338 may use the pose of the glasses 100 to generate frames of virtual content or other content to be presented on the displays 310 when the glasses 100 are functioning in a traditional augmented reality mode. In this mode, the GPU & display driver 338 generates updated frames of virtual content based on updated three-dimensional poses of the glasses 100, which reflect changes in the position and orientation of the user in relation to physical objects in the user's real-world environment.

One or more functions or operations described herein may also be performed in an application resident on the glasses 100 or on the user device 328, or on a remote server. For example, one or more functions or operations described herein may be performed by one of the applications 1006 such as messaging application 1046.

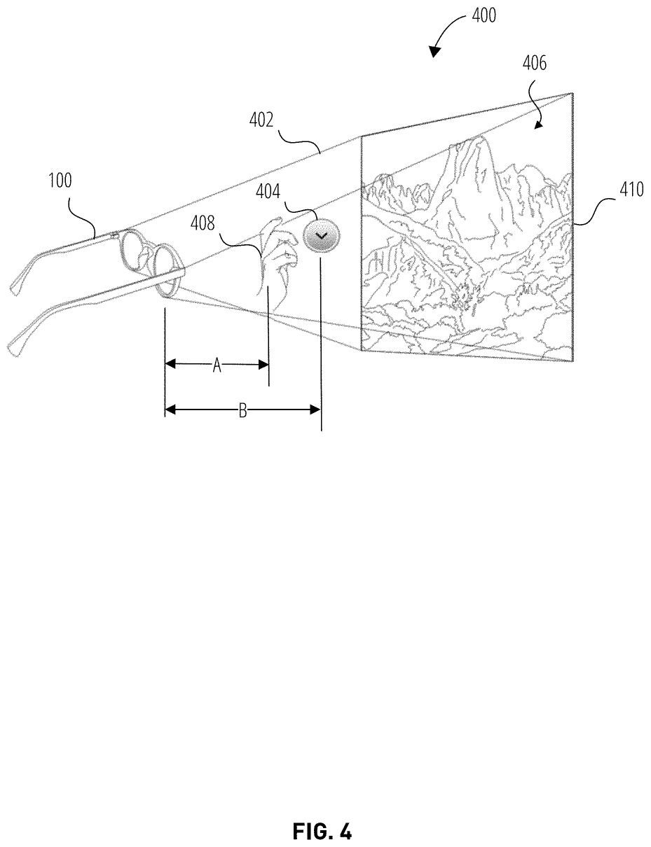

FIG. 4 depicts a user interface 400 of the glasses 100 in accordance with some examples. The glasses 100 provide a field of view 402, through which the real world 406, including the user's hand 408, can be perceived by the user. The glasses 100 capture a video feed comprising a plurality of image frames 410 of the real worlds 406, generated by the cameras 308. The captured image frames permit the glasses 100 to locate and track the position and orientation (the pose) of the glasses 100 in the real world 406, and to identify and track objects in the real world including the user's hands 408. The user's hand has an associated distance or depth A from the glasses 100.

In some examples, the glasses 100 generate a virtual hand mesh for one or both of the user's hands, the position and shape of which is updated as the user moves and flexes their hands and fingers. The hand mesh can be used internally for the determination of hand proximity and gesture detection and may also be used to provide a virtual overlay on some or all of the user's hand 408, to provide feedback to the user as discussed in more detail below.

Projected into the real world by the displays 310 of the glasses 100 is a virtual object 404. The virtual object is positioned in a frame of reference that may be with respect to the glasses 100, or fixed with respect to the real world or one or more objects in the real world. The virtual object 404 has an associated depth or distance B from the glasses 100 in this frame of reference. As far as possible, the distance from the glasses 100 of the virtual object 404, as perceived by the user of the glasses 100, is the same as the distance B from the glasses 100 in the relevant virtual frame of reference.

As discussed in more detail below, the user of the glasses can interact with the virtual object 404 by bringing the user's hand 408 into the proximity of the virtual object 404. The exact nature of the available interactions and the response of the glasses 100 or networked system 300 to particular interactions is defined by the parameters and rules associated with the particular virtual object 404.

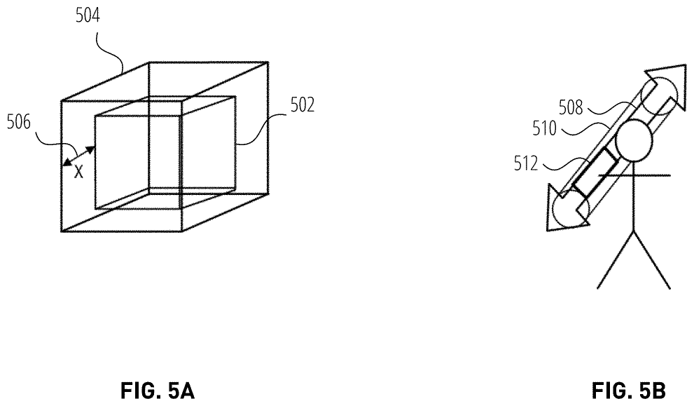

FIG. 5A and FIG. 5B illustrated two examples of interactive virtual objects and their associated rules and attributes. Rules specify the conditions that are required to trigger a feedback update for a virtual object. For example, referring to FIG. 5A, a virtual object in the nature of a 3D button 502 is defined that can be pressed or clicked by moving a hand or a finger or thumb onto it in the direction of increasing depth from the glasses 100. Associated with the 3D button 502 is a bounding box 504 that is larger than the 3D button 502 by a certain tolerance 506. Once part of the user's hand (such as a finger or thumb) is determined to be positioned within the bounding box 504, then appropriate feedback is provided, such as a change of color or visibility of the hand mesh associated with the particular hand, or a change of the color of the 3D button 502 to a specified color. The changes in visual properties or characteristics of the 3D button 502 or other virtual object may be of any kind, including changing the color of all of a portion of the virtual object or hand mesh, providing a pattern or other ornamentation, changing a virtual object's transparency, or its visibility related to other virtual objects, providing a halo effect, and so forth.

These visual cues indicate to the user that they are about to press or are able to press the 3D button 502, which state can also be reflected in the attributes of the 3D button 502 (e.g., the attributes are updated to reflect that it is in an “about to press” state.) Color change or other visual feedback can be gradual, such that the closer the finger gets to the 3D button 502 the more the color of the hand mesh or 3D button 502 changes towards the target color. This transition from the normal color to the target color happens within the tolerance distance between an edge of the boundary box and an edge of the 3D button 502.

Once the finger is within the 3D button 502, another color is used on the 3D button 502 or the hand mesh to indicate that the 3D button 502 is being pressed or has been pressed, and the attributes of the 3D button 502 can be updated into a “pressing” state or “pressed” state.

In addition to or instead of the color change, an acoustic feedback rule can be used. In some examples, once the finger or thumb or hand position is within the bounding box 504, a beeping sound starts. The closer the finger gets to the 3D button 502, the more constant or faster the beeping sound will be. Once the finger is within the bounds of the 3D button 502 a constant beep can sound (such as to indicate a “pressing state”) or the sound may be stopped. In the latter case, another indication may be used (a color or another sound) or it may otherwise be apparent from the response of the glasses 100 or the networked system 300 to the 3D button 502 press that it has been pressed, for example by commencement of the action in the application 602 associated with pressing the 3D button 502.

An interactive rod-shaped virtual object is illustrated in FIG. 5B. The interactive rod 508 is elongate and augmented along its length and is capable of augmentation in one or more segments to provide proximity feedback. The user can grasp or hold the interactive rod 508 with one or both hands. As before, a bounding box 510 is defined around the interactive rod 508, which is larger than the interactive rod 508 by a certain tolerance.

As a user's hand approaches the interactive rod 508 and intersects with the bounding box 510, then appropriate feedback is provided, such as a change of color or visibility of the hand mesh associated with the particular hand, or a change of the color of a feedback region 512 comprising a segment of the interactive rod 508 near the position of the user's hand.

These visual cues indicate to the user that they are about to interact with the interactive rod 508 and where, which states can also be reflected in the attributes of the interactive rod 508 (e.g., the attributes are updated to reflect that it is in a “ready to interact” state with an identification of the position along the interactive rod 508 of the user's hand. The color change can be gradual, such that the closer the hand gets to the interactive rod 508 the more the color of the hand mesh or the feedback region 512 changes towards the target color. This transition from the normal color to the target color happens within the tolerance distance between an edge of the boundary box and an edge of the interactive rod 508 as before. In addition to or instead of the color change, an acoustic feedback rule can be used. In some examples, once the hand position is within the bounding box 510, a beeping sound starts. The closer the hand gets to the interactive rod 508, the more constant or faster the beeping sound will be.

Once the user's hand is within the bounding box 510, a grasping gesture is required for the user to take hold of the interactive rod 508. A grasping gesture may for example be moving the hand from an open palm position to a closed finger position. Once the grasping gesture is detected, another color is used on the feedback region 512 or the hand mesh to indicate that the interactive rod 508 has been grasped, and the attributes of the interactive rod 508 can be updated into a “grasped” or “held” state with an identification of the position along the interactive rod 508 of the user's grasping hand. This can also be applied to grasping the interactive rod 508 with two hands, in which case feedback is given in the same way for the second hand and its position on the interactive rod 508, and when grasped with both hands, the attributes of the interactive rod 508 will be updated to reflect that it is being held by two hands and the positions along the interactive rod 508 along which it is being held.

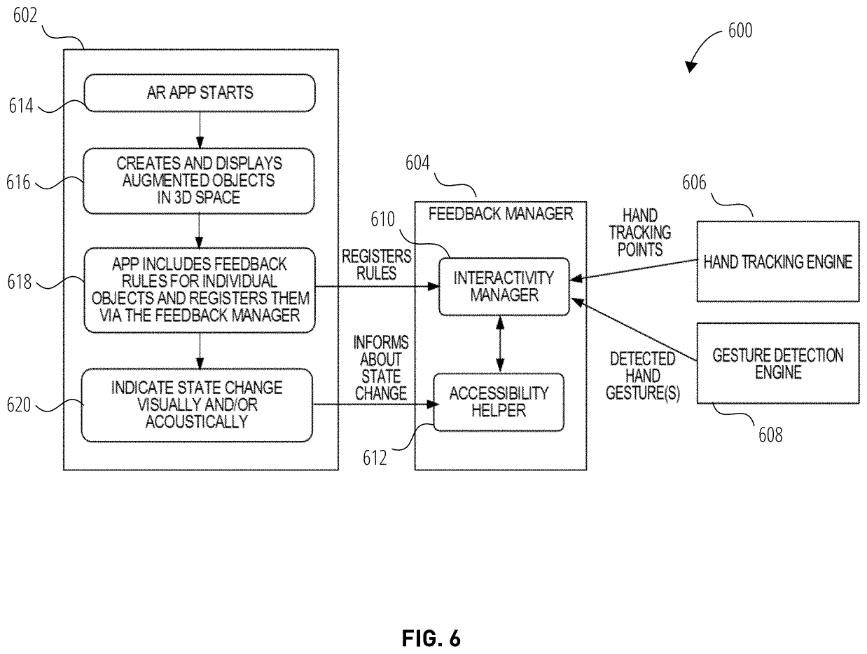

FIG. 6 illustrates a UI architecture 600 that may be used to implement feedback, according to some examples. The UI architecture 600 may be embodied in the user device 328, the glasses 100, on a server system 332 or in some combination thereof. The UI architecture 600 includes an application 602, a feedback manager 604, a hand tracking engine 606 and a gesture detection engine 608.

The application 602, after starting at block 614, performs the functions associated with its intended augmented reality functionality (such as a game, a content capture in which AR overlays or objects are displayed to the user over or embedded in the real world.) In particular the application 602 creates and displays augmented reality objects in 3D space in block 616 for display to the user of the glasses 100. The application 602 also includes virtual object attributes and rules, including the current shape, position and orientation of the virtual object, the types of interactions that can be performed on or with the object, the types of gestures that are applicable, such as grasp or button push, bounding box shape and tolerances, and so forth. These attributes and rules as provided to the feedback manager 604 in blocks 618, where the object and its attributes and rules are registered.

The application 602 also receives information about changes in the state of the object based on user interaction, and these are reported to the application 602 by the feedback manager 604 in block 620. Changes of state may for example be that a hand or digit is within the bounding box 504, is moving in a certain direction to or from the virtual object, the location on the virtual object or in the bounding box of a hand or a digit, and any relevant gestures that have been detected. The feedback manager 604 also applies the feedback rules for the particular virtual object and notifies the application 602 of the visual or audible feedback that is to be applied to the virtual object in block 620.

In response to receiving the change of state and associated feedback from the feedback manager 604, the application 602 indicates the change of state of the virtual object to the user of the glasses 100, either visually in the display of the virtual object on the displays 310, or acoustically via an associated audio transducer. The change of state of the virtual object and the associated motion of the relevant hand or digit is also reported to the application 602 so that the application 602 can take the action that corresponds to the change of state and change of hand position in the application 602 itself, such as grasping and swinging a virtual tennis racquet.

The feedback manager 604 includes an interactivity manager 610 and an accessibility helper 612. The interactivity manager 610 includes a proximity function, including an algorithm that determines the proximity of a user's hand 408 and fingers to the virtual object 404 as well as the closest points on/to the surface of the virtual object 404 to the user's hands 408 or digits (finger(s), thumb(s).) This is done based on data provided from the hand tracking engine 606, which is conventional and known in the art.

The interactivity manager 610 also includes an interactivity function, which is an algorithm that checks if a particular virtual object 404 provides interactivity and the ranges and angles relative to the object within which one or several different interactive actions can be performed. The interactivity manager 610 also checks if any relevant interactive actions are being performed on the virtual object 404 (or more than one virtual object at once using one or both hands). This is done in conjunction with the gesture detection engine 608, which detects and reports if a known gesture is being performed by the user. The gesture detection engine 608 is also conventional and known in the art. Detected gestures reported by the gesture detection engine 608 are checked by the interactivity manager 610 against a list of gestures that are applicable to the particular virtual object 404.

In use, the interactivity manager 610 receives the hand tracking data from the hand tracking engine 606 and gesture data from the gesture detection engine 608. The interactivity manager 610 determines firstly whether the user's hand is (or digit(s) are) within a bounding box of the virtual object. If so, this fact and the hand or digit position and direction of movement (if any) of the hand or digit are reported to the accessibility helper 612. The interactivity manager 610 determines secondly whether a relevant gesture for the virtual object 404, as reported by the gesture detection engine 608, is being performed while the hand or digit is within the bounding box. If so, this fact is also reported to the accessibility helper 612.

The interactivity manager 610 also monitors relevant ongoing actions or gestures performed by the user's hand while in the proximity of the virtual object, based on updated data from the hand tracking engine 606 and the gesture detection engine 608. For example, if the virtual object is one that can be grasped, moved and released, the interactivity manager 610 will report a “grasped” state to the accessibility helper 612 when this gesture is performed within the bounding box of the virtual object, the interactivity manager 610 will report hand-position updates for the relevant hand if it moves, and if a “release” gesture is detected, report a “released” state and released position and orientation to the accessibility helper 612.

The accessibility helper 612 receives the hand or digit position information and direction of movement, virtual object state and any detected relevant gestures from the interactivity manager 610. The accessibility helper 612 determines the appropriate feedback based on the virtual object state, any relevant gesture, and any associated movement of the user's hand. The accessibility helper 612 then notifies the application 602 of the feedback to be provided based on the state and information reported from the interactivity manager 610, by applying the rules and attributes relating to the particular virtual object.

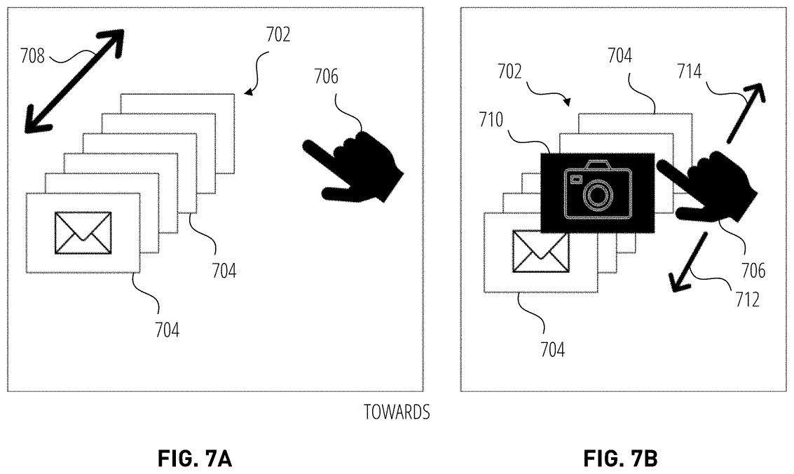

FIG. 7A and FIG. 7B illustrate user feedback provided in an AR wearable device such as the glasses 100, according to some examples. As shown in the figures, a deck 702 of stacked UI virtual objects 704 is displayed to a user of the glasses 100. The deck 702 is perceived by the user to be located in 3D space in the real-world environment in front of the user. The deck 702 of UI virtual objects 704 is arranged along, and is perceived by the user to be along, a depth direction 708 that extends at least partly towards or away from the user and the glasses 100. Also shown in the figures is a user's hand 706, which is the user's actual hand as seen through the glasses 100, although it may be augmented itself, for example with a mesh or other overlay. In FIG. 7A the user's hand 706 is far away enough from the deck 702 such that any relevant gestures performed by the hand do not affect any of the UI virtual objects 704 in the deck. That is, the user's hand 706 is outside any bounding boxes associated with the deck 702 or any of the UI virtual objects 704. The deck 702 or any of its contents are not highlighted.

The deck 702 in this case can be considered to be virtual object comprised of a number of subsidiary virtual objects, namely the UI virtual objects 704. In such a case, both the deck 702 in its entirety can have feedback associated therewith, as well as each of the UI virtual objects 704. For example, the deck could be provided with audible feedback while the individual UI virtual objects 704 are provided with visual feedback. Alternatively or in addition, visual feedback for the deck 702 might commence based on a bounding box that extends further beyond the sides of the deck 702 than those of the UI virtual object 704. In such a case, feedback for the deck 702 will be provided when a user's hand is slightly further away, and feedback for a particular UI virtual object 704 will commence as the user's hand gets closer.

In FIG. 7B, in one example the user's hand has approached the deck 702, or more correctly, the user's hand has approached the location in the real world corresponding to the location of the deck 702 in a 3D model of the surroundings that includes at least the position of one or more objects in the real world. The user's hand has intersected a bounding box around the deck 702 or around one of the UI virtual objects 704, and a particular UI virtual object 710 that corresponds to the depth of the hand 706 along the deck 702 has been highlighted to indicate that it is the UI virtual object that is available for selection or interaction. The visibility of the UI virtual object 710 relative to other of the UI virtual objects 704 has also altered so that a camera icon on the UI virtual object 710 is visible to the user.

Should the user now move their hand 706 along the side of the deck 702 towards 712 or away 714 from the glasses 100 along the depth direction 708, the UI virtual object 704 corresponding to the new depth of the user's hand will be highlighted and made visible, and the UI virtual object 710 “returned” to the deck 702 by reverting to its display attributes as shown in FIG. 7A. The user is thus able to scroll along and through the deck to identify a UI virtual object 704 with which they wish to interact.

The highlighted UI virtual object 710 in FIG. 7B can be obtained or activated by an appropriate gesture performed by the user's hand. For example, a tap motion with the user's index finger may activate the UI virtual object 710 or a function associated therewith, while a grasping motion in which the thumb and index finger are brought together may grasp the object and permit it to be dragged to a different location, where it can be released by moving the thumb and forefinger apart. The particular response to a gesture will of course depend on the implementation and the functionality of the application 602. Also, as mentioned before, varying tones or beeps may be provided instead of or in addition to a visual effect.

In some examples, the deck 702 has a bounding box associated therewith instead of bounding boxes for the individual UI virtual objects 704, and the UI virtual objects 704 instead have a depth associated therewith within the bounding box. The depth within the bounding box of the deck 702 is used to identify the UI virtual object 704 at the depth corresponding to the position of the user's hand 706, to which feedback is to be applied. This concept can be applied more generally by maintaining an index of the depths of virtual objects 404, which can be compared with the depth of the user's hand 408 for of each of the virtual objects 404. In determining whether there are any virtual objects 404 with which the user can interact, all virtual objects in the index that are not at the depth of one of the user's hands 408 can be rejected for further consideration. Virtual objects 404 that are at the depth of one of the user's hands 408 can then be checked to see if one of the user's hands 408 is in a bounding box for feedback and whether or not any relevant gestures are being performed.

In further examples, adjacent or surrounding virtual objects 404 in the vicinity of the one that is capable of interaction are also enhanced or highlighted to provide additional feedback. The feedback applied to nearby virtual objects may be less distinct than the feedback provided on or to the selectable virtual object. For example, in a grid or array of virtual objects, the virtual objects surrounding the selectable virtual object may be provided with highlighting in addition to highlighting of the selectable virtual object, but to a lesser degree, or a paler shade of a highlighting color may be applied than the color applied to the virtual object 404. This provides additional feedback to help the user select the right virtual object.

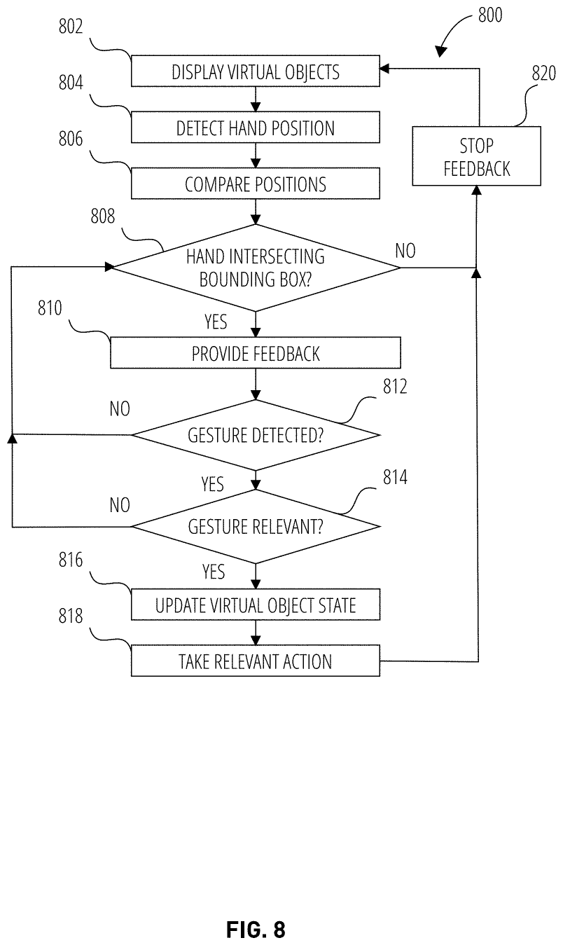

FIG. 8 is a flowchart 800 illustrating a method of providing feedback according to some examples. For explanatory purposes, the operations of the flowchart 800 are described herein as occurring in serial, or linearly. However, multiple operations of the flowchart 800 may occur in parallel. In addition, the operations of the flowchart 800 need not be performed in the order shown and/or one or more blocks of the flowchart 800 need not be performed and/or can be replaced by other operations.

Operations illustrated in FIG. 8 will typically execute on the glasses 100. In other examples, the operations are performed jointly between an application running on the user device 328 and the data processor 302 and associated hardware in or associated with the glasses 100. For the purposes of clarity, flowchart 800 is discussed herein with reference to such an example. Various implementations are of course possible, with some of the operations taking place in server system 332, or with one application calling another application or SDK for required functionality.

The method commences at operation 802, with the glasses 100 in conjunction with the application 602, displaying one or more virtual objects 404 on the displays 310 of the glasses 100. The nature of the display of the virtual objects 404 is determined by the functionality of the application 602, user inputs, the position and orientation of the glasses 100 in the real world, the position and orientation of objects or people in the real world, and so forth. The application 602 has also registered feedback rules for individual virtual objects 404 with the feedback manager 604, and provides updated positional information for the virtual objects 404 as the glasses 100 move in the environment and based on the functionality of the application 602. The virtual objects 404 in this case are the virtual objects 404 with which the user can interact with hand gestures, and not virtual objects that are inert as regards hand gestures.

In operation 804, the position of at least one of the user's hands 408 is detected by the hand tracking engine 606 and reported to the feedback manager 604, and in operation 806 the feedback manager 604 compares the position of the user's hand 408 to the positions of the virtual objects 404.

In some examples, this can be a two-step process, with an initial comparison being done between the depth A (see FIG. 4) of a user's hand 408 being compared with the depth B of each of the virtual objects 404. If the depth A of the user's hand 408 is not within a range of depths corresponding to a bounding box (such as bounding box 504 or bounding box 510) of one of the virtual objects 404, then the user's hand 408 cannot be intersecting a bounding box. In such a case the test in operation 808 fails and the method returns to operation 802 where the display of virtual objects 404 continues. In the event that any feedback had previously been provided based on an intersection of the user's hand 408 with a virtual object 404, this feedback stops in operation 820 since the hand is no longer intersecting any bounding box.

If the depth A of the user's hand 408 is within a range of depths corresponding to a bounding box (such as bounding box 504 or bounding box 510) of one of the virtual objects 404, then the user's hand 408 may be intersecting a bounding box. In such a case, any virtual objects not at the relevant depth are eliminated from further consideration. The position of the user's hand 408 against any remaining virtual object 404 is checked in a plane perpendicular to the depth direction at the particular depth A of the user's hand 408, that is, in x and y directions if z is the depth direction. If the position of the user's hand is not within a bounding box of a remaining virtual object 404 based on this comparison, then the test in operation 808 fails and the method returns to operation 802 where the display of virtual objects 404 continues.

If the position of the user's hand is within a bounding box of a remaining virtual object 404 then the test in operation 808 passes and the method continues at operation 810. In operation 810, visual or acoustic feedback is provided by the glasses 100 to the user to indicate that the user's hand 408 is in position to interact with the particular virtual object 404 as discussed in more detail above. This may occur by the interactivity manager 610 reporting the intersection of the user's hand 408 with the bounding box of the particular virtual object 404 to the accessibility helper 612. The accessibility helper 612 determines the appropriate feedback by applying the rules and attributes relating to the particular virtual object, and the accessibility helper 612 then notifies the application 602 of the feedback to be provided. The feedback is then provided by the glasses 100 as defined and directed by the application 602.

Concurrently with these operations, the gesture detection engine 608 is reporting any detected gestures to the feedback manager 604. If no gestures are detected in operation 812, the method returns to operation 808 where it is checked whether the hand is still intersecting the bounding box of the relevant virtual object 404, as well as whether or not the hand is intersecting the bounding box of any other virtual objects, and the method continues from there.

If a gesture is detected and reported to the interactivity manager 610 in operation 812, then the interactivity manager 610 checks in operation 814 to see whether the gesture is applicable to the relevant virtual object 404 whose bounding box is being intersected by the user's hand 408 that has performed the gesture. If the gesture is not applicable to the particular virtual object 404, then the method returns to operation 808 and continues from there.

If the detected gesture is applicable to the relevant virtual object as determined in operation 814, then the interactivity manager 610 updates the state of the relevant virtual object 404 if applicable (for example to a “grasped” state or a “button pushed” state) in operation 816. The interactivity manager 610 then reports the hand (or digit) position information and direction of movement received from the hand tracking engine 606, the updated virtual object state, and the relevant gesture to the accessibility helper 612. The accessibility helper 612 determines any appropriate feedback based on the virtual object state, the relevant gesture, and any associated movement of the user's hand, by applying the rules and attributes relating to the particular virtual object. The accessibility helper 612 then notifies the application 602 of the feedback to be provided based on the state and information reported from the interactivity manager 610, if any. The virtual object state, the relevant gesture, and any associated movement of the user's hand is also reported to the application 602, which then takes relevant action in operation 818 based on the functionality of the application 602.

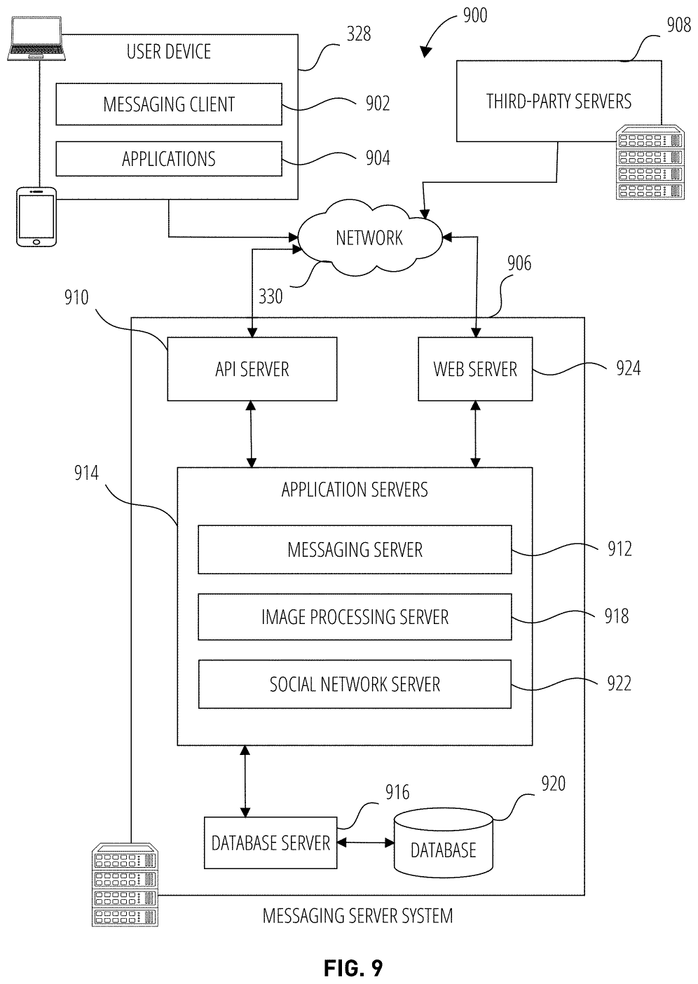

FIG. 9 is a block diagram showing an example messaging system 900 for exchanging data (e.g., messages and associated content) over a network. The messaging system 900 includes multiple instances of a user device 328 which host a number of applications, including a messaging client 902 and other applications 904. A messaging client 902 is communicatively coupled to other instances of the messaging client 902 (e.g., hosted on respective other user devices 328), a messaging server system 906 and third-party servers 908 via a network 330 (e.g., the Internet). A messaging client 902 can also communicate with locally-hosted applications 904 using Application Program Interfaces (APIs).

A messaging client 902 is able to communicate and exchange data with other messaging clients 902 and with the messaging server system 906 via the network 330. The data exchanged between messaging clients 902, and between a messaging client 902 and the messaging server system 906, includes functions (e.g., commands to invoke functions) as well as payload data (e.g., text, audio, video or other multimedia data).

The messaging server system 906 provides server-side functionality via the network 330 to a particular messaging client 902. While some functions of the messaging system 900 are described herein as being performed by either a messaging client 902 or by the messaging server system 906, the location of some functionality either within the messaging client 902 or the messaging server system 906 may be a design choice. For example, it may be technically preferable to initially deploy some technology and functionality within the messaging server system 906 but to later migrate this technology and functionality to the messaging client 902 where a user device 328 has sufficient processing capacity.

The messaging server system 906 supports various services and operations that are provided to the messaging client 902. Such operations include transmitting data to, receiving data from, and processing data generated by the messaging client 902. This data may include message content, user device information, geolocation information, media augmentation and overlays, message content persistence conditions, social network information, and live event information, as examples. Data exchanges within the messaging system 900 are invoked and controlled through functions available via user interfaces (UIs) of the messaging client 902.

Turning now specifically to the messaging server system 906, an Application Program Interface (API) server 910 is coupled to, and provides a programmatic interface to, application servers 914. The application servers 914 are communicatively coupled to a database server 916, which facilitates access to a database 920 that stores data associated with messages processed by the application servers 914. Similarly, a web server 924 is coupled to the application servers 914, and provides web-based interfaces to the application servers 914. To this end, the web server 924 processes incoming network requests over the Hypertext Transfer Protocol (HTTP) and several other related protocols.

The Application Program Interface (API) server 910 receives and transmits message data (e.g., commands and message payloads) between the user device 328 and the application servers 914. Specifically, the Application Program Interface (API) server 910 provides a set of interfaces (e.g., routines and protocols) that can be called or queried by the messaging client 902 in order to invoke functionality of the application servers 914. The Application Program Interface (API) server 910 exposes various functions supported by the application servers 914, including account registration, login functionality, the sending of messages, via the application servers 914, from a particular messaging client 902 to another messaging client 902, the sending of media files (e.g., images or video) from a messaging client 902 to a messaging server 912, and for possible access by another messaging client 902, the settings of a collection of media data (e.g., story), the retrieval of a list of friends of a user of a user device 328, the retrieval of such collections, the retrieval of messages and content, the addition and deletion of entities (e.g., friends) to an entity graph (e.g., a social graph), the location of friends within a social graph, and opening an application event (e.g., relating to the messaging client 902).

The application servers 914 host a number of server applications and subsystems, including for example a messaging server 912, an image processing server 918, and a social network server 922. The messaging server 912 implements a number of message processing technologies and functions, particularly related to the aggregation and other processing of content (e.g., textual and multimedia content) included in messages received from multiple instances of the messaging client 902. As will be described in further detail, the text and media content from multiple sources may be aggregated into collections of content (e.g., called stories or galleries). These collections are then made available to the messaging client 902. Other processor and memory intensive processing of data may also be performed server-side by the messaging server 912, in view of the hardware requirements for such processing.

The application servers 914 also include an image processing server 918 that is dedicated to performing various image processing operations, typically with respect to images or video within the payload of a message sent from or received at the messaging server 912.

The social network server 922 supports various social networking functions and services and makes these functions and services available to the messaging server 912. To this end, the social network server 922 maintains and accesses an entity graph within the database 920. Examples of functions and services supported by the social network server 922 include the identification of other users of the messaging system 900 with which a particular user has relationships or is “following,” and also the identification of other entities and interests of a particular user.

The messaging client 902 can notify a user of the user device 328, or other users related to such a user (e.g., “friends”), of activity taking place in shared or shareable sessions. For example, the messaging client 902 can provide participants in a conversation (e.g., a chat session) in the messaging client 902 with notifications relating to the current or recent use of a game by one or more members of a group of users. One or more users can be invited to join in an active session or to launch a new session. In some examples, shared sessions can provide a shared augmented reality experience in which multiple people can collaborate or participate.

FIG. 10 is a block diagram 1000 illustrating a software architecture 1004, which can be installed on any one or more of the devices described herein. The software architecture 1004 is supported by hardware such as a machine 1002 that includes processors 1020, memory 1026, and I/O components 1038. In this example, the software architecture 1004 can be conceptualized as a stack of layers, where individual layers provides a particular functionality. The software architecture 1004 includes layers such as an operating system 1012, libraries 1008, frameworks 1010, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, processor management (e.g., scheduling), component management, networking, and security settings, among other functionalities. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1008 provide a low-level common infrastructure used by the applications 1006. The libraries 1008 can include system libraries 1018 (e.g., C standard library) that provide functions such as memory allocation functions, string manipulation functions, mathematic functions, and the like. In addition, the libraries 1008 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement 3D user interfaces), image feature extraction libraries (e.g. OpenIMAJ), database libraries (e.g., SQLite to provide various relational database functions), web libraries (e.g., WebKit to provide web browsing functionality), and the like. The libraries 1008 can also include a wide variety of other libraries 1028 to provide many other APIs to the applications 1006.

The frameworks 1010 provide a high-level common infrastructure that is used by the applications 1006. For example, the frameworks 1010 provide various graphical user interface (GUI) functions, high-level resource management, and high-level location services. The frameworks 1010 can provide a broad spectrum of other APIs that can be used by the applications 1006, some of which may be specific to a particular operating system or platform.

In an example, the applications 1006 may include a home application 1036, a contacts application 1030, a browser application 1032, a book reader application 1034, a location application 1042, a media application 1044, a messaging application 1046, a game application 1048, and a broad assortment of other applications such as third-party applications 1040. The applications 1006 are programs that execute functions defined in the programs. Various programming languages can be employed to create one or more of the applications 1006, structured in a variety of manners, such as object-oriented programming languages (e.g., Objective-C, Java, or C++) or procedural programming languages (e.g., C or assembly language). In a specific example, the third-party applications 1040 (e.g., applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party applications 1040 can invoke the API calls 1050 provided by the operating system 1012 to facilitate functionality described herein.

FIG. 11 is a diagrammatic representation of a machine 1100 within which instructions 1110 (e.g., software, a program, an application, an applet, an app, or other executable code) for causing the machine 1100 to perform any one or more of the methodologies discussed herein may be executed. For example, the instructions 1110 may cause the machine 1100 to execute any one or more of the methods described herein. The instructions 1110 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a head-worn device (e.g., a smart watch), a smart home device (e.g., a smart appliance), other smart devices, a web appliance, a network router, a network switch, a network bridge, or any machine capable of executing the instructions 1110, sequentially or otherwise, that specify actions to be taken by the machine 1100. Further, while a single machine 1100 is illustrated, the term “machine” may also be taken to include a collection of machines that individually or jointly execute the instructions 1110 to perform any one or more of the methodologies discussed herein.

The machine 1100 may include processors 1102, memory 1104, and I/O components 1106, which may be configured to communicate with one another via a bus 1144. In an example, the processors 1102 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1108 and a processor 1112 that execute the instructions 1110. The term “processor” is intended to include multi-core processors that may comprise two or more independent processors (sometimes referred to as “cores”) that may execute instructions contemporaneously. Although FIG. 11 shows multiple processors 1102, the machine 1100 may include a single processor with a single core, a single processor with multiple cores (e.g., a multi-core processor), multiple processors with a single core, multiple processors with multiples cores, or any combination thereof.

The memory 1104 includes a main memory 1114, a static memory 1116, and a storage unit 1118, both accessible to the processors 1102 via the bus 1144. The main memory 1104, the static memory 1116, and storage unit 1118 store the instructions 1110 embodying any one or more of the methodologies or functions described herein. The instructions 1110 may also reside, completely or partially, within the main memory 1114, within the static memory 1116, within machine-readable medium 1120 within the storage unit 1118, within one or more of the processors 1102 (e.g., within the processor's cache memory), or any suitable combination thereof, during execution thereof by the networked system 300.

The I/O components 1106 may include a wide variety of components to receive input, provide output, produce output, transmit information, exchange information, capture measurements, and so on. The specific I/O components 1106 that are included in a particular machine will depend on the type of machine. For example, portable machines such as mobile phones may include a touch input device or other such input mechanisms, while a headless server machine will likely not include such a touch input device. It will be appreciated that the I/O components 1106 may include many other components that are not shown in FIG. 11. In various examples, the I/O components 1106 may include output components 1128 and input components 1132. The output components 1128 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1132 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1106 may include biometric components 1134, motion components 1136, environmental components 1138, or position components 1140, among a wide array of other components. For example, the biometric components 1134 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1136 include acceleration sensor components (e.g., accelerometer), gravitation sensor components, rotation sensor components (e.g., gyroscope), and so forth. The environmental components 1138 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1140 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1106 further include communication components 1142 operable to couple the networked system 300 to a network 1122 or devices 1124 via a coupling 1130 and a coupling 1126, respectively. For example, the communication components 1142 may include a network interface component or another suitable device to interface with the network 1122. In further examples, the communication components 1142 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1124 may be another machine or any of a wide variety of peripheral devices (e.g., a peripheral device coupled via a USB).

Moreover, the communication components 1142 may detect identifiers or include components operable to detect identifiers. For example, the communication components 1142 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1142, such as location via Internet Protocol (IP) geolocation, location via Wi-Fi® signal triangulation, location via detecting an NFC beacon signal that may indicate a particular location, and so forth.

The various memories (e.g., memory 1104, main memory 1114, static memory 1116, and/or memory of the processors 1102) and/or storage unit 1118 may store one or more sets of instructions and data structures (e.g., software) embodying or used by any one or more of the methodologies or functions described herein. These instructions (e.g., the instructions 1110), when executed by processors 1102, cause various operations to implement the disclosed examples.

The instructions 1110 may be transmitted or received over the network 1122, using a transmission medium, via a network interface device (e.g., a network interface component included in the communication components 1142) and using any one of a number of well-known transfer protocols (e.g., hypertext transfer protocol (HTTP)). Similarly, the instructions 1110 may be transmitted or received using a transmission medium via the coupling 1126 (e.g., a peer-to-peer coupling) to the devices 1124.

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “user device” or “client device” refers to any machine that interfaces to a communications network to obtain resources from one or more server systems or other user or client devices. A user or client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing some operations and may be configured or arranged in a particular physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform some operations as described herein. A hardware component may also be implemented mechanically, electronically, or any suitable combination thereof. For example, a hardware component may include dedicated circuitry or logic that is permanently configured to perform some operations. A hardware component may be a special-purpose processor, such as a field-programmable gate array (FPGA) or an Application Specific Integrated Circuit (ASIC). A hardware component may also include programmable logic or circuitry that is temporarily configured by software to perform some operations. For example, a hardware component may include software executed by a general-purpose processor or other programmable processor. Once configured by such software, hardware components become specific machines (or specific components of a machine) tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) is to be understood to encompass a tangible entity, be that an entity that is physically constructed, permanently configured (e.g., hardwired), or temporarily configured (e.g., programmed) to operate in a particular manner or to perform some operations described herein. Considering examples in which hardware components are temporarily configured (e.g., programmed), the hardware components may not be configured or instantiated at any one instance in time. For example, where a hardware component comprises a general- purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be partially processor-implemented, with a particular processor or processors being an example of hardware. For example, some of the operations of a method may be performed by one or more processors or processor-implemented components. Moreover, the one or more processors may also operate to support performance of the relevant operations in a “cloud computing” environment or as a “software as a service” (SaaS). For example, at some of the operations may be performed by a group of computers (as examples of machines including processors), with these operations being accessible via a network (e.g., the Internet) and via one or more appropriate interfaces (e.g., an API). The performance of some of the operations may be distributed among the processors, residing within a single machine as well as being deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

A “computer-readable medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

1. A computer-implemented method for providing feedback in a display device including a camera, comprising:
displaying a virtual object on the display device;
tracking a user's first hand in a field of view of the camera;
determining proximity of the user's first hand to the virtual object;
based on proximity of the user's first hand to the virtual object, providing user feedback comprising changing a graphical property of a first region of the virtual object at a first location on the virtual object corresponding to the proximity of the user's first hand;
tracking a user's second hand in the field of view of the camera;
determining proximity of the user's second hand to the virtual object; and
based on proximity of the user's second hand to the virtual object, changing a graphical property of a second region of the virtual object at a second location along the virtual object corresponding to the proximity of the user's second hand while maintaining the change in the graphical property of the first region of the virtual object corresponding to the proximity of the user's first hand.

2. The computer-implemented method of claim 1 further comprising:
detecting a gesture performed by the user's first or second hand when the user's first or second hand respectively is in proximity to the virtual object;
determining that the gesture is applicable to the virtual object; and
based on determining that the gesture is applicable to the virtual object, updating a state of the virtual object.

3. The computer-implemented method of claim 1 wherein determining the proximity of the user's first or second hand to the virtual object comprises:
determining intersection of the user's first or second hand respectively with a bounding box surrounding the virtual object.

4. The computer-implemented method of claim 1, further comprising:
comparing a depth from the display device to the user's first or second hand with a depth from the display device to the virtual object; and
based on the depth from the display device to the user's first or second hand respectively not being within a range of the depth from the display device to the virtual object, determining that the user's first or second hand respectively is not in proximity to the virtual object.

5. The computer-implemented method of claim 1, further comprising:
displaying a plurality of virtual objects on the display device, each virtual object having an associated depth from the display device;
comparing a depth from the display device to the user's first or second hand with each of the depths of the plurality of virtual objects; and
based on the depth from the display device to the user's first or second hand respectively not being within a range of the depth from the display device to a particular virtual object, determining that the user's first or second hand respectively is not in proximity to the particular virtual object.

6. The computer-implemented method of claim 1, further comprising:
detecting a grasping gesture performed by the user's first hand in proximity to the virtual object;
based on detecting the grasping gesture performed by the user's first hand, changing the graphical property of the first region of the virtual object corresponding to the proximity of the user's first hand for a second time;
detecting a grasping gesture performed by the user's second hand in proximity to the virtual object;
based on detecting the grasping gesture performed by the user's second hand, changing the graphical property of the second region of the virtual object corresponding to the proximity of the user's first hand for a second time; and
based on detecting a grasping gesture performed by both the user's first hand and the user's second hand, updating an attribute of the virtual object to reflect that it is being held by two hands.

7. (canceled)

8. The computer-implemented method of claim 1, wherein the feedback comprises audio feedback that increases in frequency as either the user's first or second hand approaches the virtual object.

9. The computer-implemented method of claim 1, wherein the feedback comprises changing visual properties of other virtual objects in a vicinity of the virtual object.

10. A non-transitory computer-readable storage medium, the non-transitory computer-readable storage medium including instructions that when executed by a computer, cause the computer to perform operations for providing feedback in a display device including a camera, comprising:
displaying a virtual object on the display device;
tracking a user's first hand in a field of view of the camera;
determining proximity of the user's first hand to the virtual object;
based on proximity of the user's first hand to the virtual object, providing user feedback comprising changing a graphical property of a first region of the virtual object at a first location on the virtual object corresponding to the proximity of the user's first hand;
tracking a user's second hand in the field of view of the camera;
determining proximity of the user's second hand to the virtual object; and
based on proximity of the user's second hand to the virtual object, changing a graphical property of a second region of the virtual object at a second location along the virtual object corresponding to the proximity of the user's second hand while maintaining the change in the graphical property of the virtual object at the first region of the virtual object corresponding to the proximity of the user's first hand.

11. The non-transitory computer-readable storage medium of claim 10 wherein determining the proximity of the user's first or second hand to the virtual object comprises:
determining intersection of the user's first or second hand respectively with a bounding box surrounding the virtual object.

12. The non-transitory computer-readable storage medium of claim 10, wherein the operations further comprise:
comparing a depth from the display device to the user's first or second hand with a depth from the display device to the virtual object; and
based on the depth from the display device to the user's first or second hand not being within a range of the depth from the display device to the virtual object, determining that the user's first or second hand is not in proximity to the virtual object.

13. (canceled)

14. The non-transitory computer-readable storage medium of claim 10, the operations further comprising:
detecting a grasping gesture performed by the user's first hand in proximity to the virtual object;
based on detecting the grasping gesture performed by the user's first hand, changing the graphical property of a first region of virtual object at the first location on the virtual object corresponding to the proximity of the user's first hand for a second time;
detecting a grasping gesture performed by the user's second hand in proximity to the virtual object;
based on detecting the grasping gesture performed by the user's second hand, changing the graphical property of the second region of the virtual object at the second location on the virtual object corresponding to the proximity of the user's first hand for a second time; and
based on detecting a grasping gesture performed by both the user's first hand and the user's second hand, updating an attribute of the virtual object to reflect that it is being held by two hands.

15. The non-transitory computer-readable storage medium of claim 10, wherein the feedback comprises changing visual properties of other virtual objects in a vicinity of the virtual object.

16. A computing apparatus comprising:
at least one processor; and
a memory storing instructions that, when executed by the at least one processor, configure the computing apparatus to perform operations for providing feedback in a display device including a camera, comprising:
displaying a virtual object on the display device;
tracking a user's first hand in a field of view of the camera;
determining proximity of the user's first hand to the virtual object;
based on proximity of the user's first hand to the virtual object, providing user feedback comprising changing a graphical property of a first region of the virtual object at a first location on the virtual object corresponding to the proximity of the user's first hand;
tracking a user's second hand in the field of view of the camera;
determining proximity of the user's second hand to the virtual object; and
based on proximity of the user's second hand to the virtual object, changing a graphical property of a second region of the virtual object at a second location on the virtual object corresponding to the proximity of the user's second hand while maintaining the change in the graphical property of the virtual object at the first region of the virtual object corresponding to the proximity of the user's first hand.

17. The computing apparatus of claim 16 wherein the operations further comprise:
detecting a gesture performed by the user's first or second hand when the user's first or second hand respectively is in proximity to the virtual object;
determining that the gesture is applicable to the virtual object; and
based on determining that the gesture is applicable to the virtual object, updating a state of the virtual object.

18. The computing apparatus of claim 16 wherein the operations further comprise:
detecting a grasping gesture performed by the user's first hand in proximity to the virtual object;
based on detecting the grasping gesture performed by the user's first hand, changing the graphical property of the virtual object at the first region of the virtual object corresponding to the proximity of the user's first hand, for a second time;
detecting a grasping gesture performed by the user's second hand in proximity to the virtual object;
based on detecting the grasping gesture performed by the user's second hand, changing the graphical property of the virtual object at the second region of the virtual object corresponding to the proximity of the user's first hand, for a second time; and
based on detecting a grasping gesture performed by both the user's first hand and the user's second hand, updating an attribute of the virtual object to reflect that it is being held by two hands.

19. The computing apparatus of claim 16 wherein determining the proximity of the user's first or second hand to the virtual object comprises:
determining intersection of the user's first or second hand respectively with a bounding box surrounding the virtual object.

20. The computing apparatus of claim 16 wherein the feedback comprises audio feedback that increases in frequency as either the user's first or second hand approaches the virtual object.
